(19) United States
(12) Patent Application Publication
(10) Pub. No.: US 2017/0374466 A1
(43) Pub. Date: Dec. 28, 2017

(54) SYSTEM, METHOD AND APPARATUS FOR SUPPRESSING CROSSTALK

(71) Applicant: MQN PTY LTD, ST. LUCIA (AU)

(72) Inventor: Ngoc Huong Francis Pham, St. Lucia (AU)

(21) Appl. No.: 15/635,423

(22) Filed: Jun. 28, 2017

(30) Foreign Application Priority Data
Jun. 28, 2016 (AU) 2016902521

(51) Int. Cl. H04R 3/14; H04R 3/04; H04R 5/033; H04R 5/04

(52) U.S. Cl. CPC H04R 3/14; H04R 5/04; H04R 3/04; H04R 5/033; H04R 2430/01

(57) ABSTRACT

A crosstalk suppression system includes one or more proximal audio output devices located proximal to a listener's left and/or right ear; and one or more distal audio output sources located relatively away from the listener's ears; wherein each of the proximal output devices and the distal audio output sources are adapted to emit a substantially identical sound without introducing an active time delay for the sound emitted from the proximal audio output devices and the distal audio output sources such that during use the listener's left and/or right ear receives sound from the proximal audio output devices before or at the same time relative to the sound received by the listener's ear from the distal audio output sources and wherein loudness of the sound emitted from the proximal audio output devices does not exceed a loudness of the sound emitted from the distal audio output sources.

### PRIORITY

This application claims priority to Australian Provisional Patent Application No. 2016902521, filed 28 Jun. 2016, and all the benefits accruing therefrom under 35 U.S.C. §119, the contents of which in its entirety are herein incorporated by reference.

### TECHNICAL FIELD

The present invention pertains generally to a system, method and apparatus for suppressing crosstalk.

### BACKGROUND

There are a number of acoustical phenomena that often result in reducing the overall audio quality for a listener. Crosstalk is one such phenomena which occurs when two loudspeakers play the same audio program, creating a phantom center image.

In an ideal scenario, the left ear of the listener should only hear sounds emitted from the speakers positioned to the left of the listener, and the listener's right ear should only hear the sounds from the speakers positioned to the right of the listener. However, in reality, each ear of the listener will hear the sound from both the speakers positioned on the left and right side of the listener. When the left ear of the listener hears the sound from the right speakers, or when the right ear hears the sound from the left speakers, these cross hearing sounds is called crosstalk.

Phantom image of the sound is perceived by a listener listening to sounds emanating from stereo systems or surround sound systems particularly when there are more than one sound sources and more than one sound channels that are being used for producing the audio program. In a multichannel audio playback system, the creation of a phantom image between any two (or more) loudspeakers can create the illusion of additional speaker array or (more importantly) adding to the overall realism of the listening experience of a user.

As explained in the above paragraphs, the issue of crosstalk can have a detrimental effect on the creation of the phantom image of the sound in such a multichannel audio playback system. Therefore, it is important to address the issue of crosstalk for improving the overall listening experience of the user.

One way of overcoming the issue of crosstalk is to use headphones because the sound from a left earpiece of a headphone does not usually travel to the listener's right ear. Similarly, sound from a listener's right earpiece also does not travel to the listener's left ear. Whilst, headphones are suitable for private listening, they fail to provide the spacious effect that is provided by external sound sources such as external speakers. Headphone users often perceive the undesirable effect that the sound seems to come from inside of the listener's head.

Another way of overcoming the issue of crosstalk is to introduce a pre-determined delay selectively into one or more sound channels driving one or more of the speakers. However, the problem associated with introducing pre-determined delays in this manner is that the delay needs to be varied every time the listener's spatial orientation relative to the speakers is changed. Yet another problem with introducing delays in a sound production system is that when more than one listener is involved. then a customised delay for each and every listener cannot be introduced. As a result, delay based sound systems do not provide a customised listening experience that is devoid of crosstalk.

In view of the above, there is at least a need for providing an improved listening experience for a listener by addressing the problems associated with crosstalk.

### SUMMARY OF INVENTION

In a first aspect, the invention provides a crosstalk suppression system comprising: one or more proximal audio output devices located proximal to a listener's left and/or right ear; and one or more distal audio output sources located relatively away from the listener's ears; wherein each of the proximal output devices and the distal audio output sources are adapted to emit a substantially identical sound without introducing an active time delay for the sound emitted from the proximal audio output devices and the distal audio output sources such that during use the listener's left and/or right ear receives sound from the proximal audio output devices before or at the same time relative to the sound received by the listener's ear from the distal audio output sources and wherein loudness of the sound emitted from the proximal audio output devices, as heard by the listener's ears, does not exceed a loudness of the sound emitted from the distal audio output sources, as heard by the listener's ears.

In a second aspect, the invention provides a method for suppressing crosstalk for a listener, the method comprising: driving one or more proximal audio output devices for emitting a first sound output, the proximal audio output devices being located proximal to the listener's left and/or right ear; and driving one or more distal audio output devices for emitting a second sound output, the distal audio output devices being located relatively away from the listener without introducing an active time delay for the sound signal driving each of the proximal and the distal audio output devices; wherein the listener's left and/or right ear receives sound from the proximal audio output devices before or at the same time relative to the sound received by the listener's ear from the distal audio output devices and wherein loudness of the sound emitted from the proximal audio output devices, as heard by the listener's ears, does not exceed a loudness of the sound emitted from the distal audio output devices, as heard by the listener's ears.

In at least some embodiments, sound from the same soundtrack or audio files may be emitted by the proximal and distal audio output sources. In other alternative embodiments, the sound track played by the distal audio output source may have slight differences in comparison with the soundtrack played by the proximal audio output devices whilst having substantially common sound signals.

In an embodiment, the proximal audio output devices comprises at least a left proximal audio output device positioned in close proximity to the listener's left ear and a right proximal audio output device positioned in close proximity to the listener's right ear such that during use the sound emitted from the right earpiece is substantially directed to the listener's right ear and the sound emitted from the left earpiece is substantially directed to the listener's left ear.

Preferably, said left proximal audio output device comprises a left earpiece and said right proximal audio output device comprises a right earpiece wherein the left and right earpiece are preferably provided on a headset.

In an embodiment, the proximal audio output device further comprises an additional group of proximal audio output devices positioned adjacent said left proximal audio output device and/or right audio output device.

In one embodiment, the sound emitted by the proximal audio output devices and the distal audio output sources are provided by the same audio signal source. In an alternative embodiment, the sound emitted by the proximal audio output devices and the distal audio sources may be provided by different audio signal sources.

In an embodiment, the system further comprises one or more volume controllers for controlling volume of the sound emitted by the one or more proximal audio output devices. Preferably, the one or more volume controllers are adapted for ensuring that the volume of the sound emitted by the one or more proximal audio output devices does not exceed a pre-determined level. Furthermore, the one or more volume controllers may be adapted to allow adjustment of volume for several frequency bands.

In an embodiment, the proximal audio output devices are driven by sound signals provided by the one or more sound channels wherein the sound signals are received from microphones located for sensing sound emitted by the distal audio output sources and transmitting the received sound to the proximal audio output devices.

In an embodiment, the distal audio output sources comprise at least two groups of distal audio output devices wherein a first group of distal audio output devices comprises at least a first speaker; and a second group of distal audio output device comprises at least a second speaker and wherein the first group of distal audio output devices is adapted for use at the front left of a listener's location and the second group of distal audio output devices is adapted for use at the front right of the listener's location. Preferably, the system further comprises a third group of distal audio output devices comprising at least a third speaker adapted for use at a location that is substantially equidistant from the audio output devices of the first group and from the second group and located at the front of the listener's location. The system may further comprise a fourth group of distal audio output devices comprising at least a fourth speaker adapted for use at a location that is located substantially behind the listener during use.

In a third aspect, the invention provides a cross talk suppression apparatus, the apparatus comprising: a frame having one or more proximal audio output devices located proximal to a listener's left and/or right ear to allow the listener to receive at least a first sound output from said one or more proximal audio output devices wherein the proximal audio output devices are adapted to be connected to one or more audio input interfaces, said interfaces being adapted to generate one or more sounds that are substantially identical to one or more sounds emitted by one or more distal sound sources located relatively away from the listener's ears, the proximal audio output devices being mounted on the frame in a spaced relationship relative to the listener's left and/or right ear in a listening configuration to allow the listener to simultaneously receive a first and second sound output, the first output being provided by the proximal audio output devices and the second output being provided by the one or more distal audio output sources; and one or more volume controllers for controlling volume of the sound emitted by the one or more proximal audio output devices wherein preferably the one or more volume controllers are adapted for ensuring that the volume of the sound emitted by the one or more proximal audio output devices, as heard by the listener's ears, does not exceed loudness of distal sounds, as heard by the listener's ears.

In an embodiment, one or more proximal audio output devices comprises a left earpiece positioned to substantially expose the left ear and left ear canal to the air and a right earpiece positioned to substantially expose the right ear and right ear canal to the air.

In an embodiment, the frame comprises a left earpiece mounting portion for mounting the left earpiece in a spaced relationship from the left ear and a right earpiece mounting portion for mounting the right earpiece in a spaced relationship from the right ear, said earpiece mounting portions being located at end portions of a headband portion.

In some situations such as a live concert, the above components of the system can be provided by different persons. For example, the organiser provides the distal audio output source in the form of distal output devices and the listener provides a personal set of proximal audio output devices in a form of a headphone. The signal for the proximal audio output devices can be provided from the organiser in the form of an audio plug to each seat as in air planes, or wireless transmission where the listener would provide personal receiver and amplifier for use with the listener's personal of proximal audio output devices

The applicants have found that providing the sound output from the proximal audio output devices followed by another sound output of the same sound signal (such as a soundtrack) separated by a sufficiently short time delay (which is preferably below the listener's echo delay threshold), results in the listener perceiving a single fused auditory image cued by the first arrived wavefront, even when volume of sound emitted from the proximate audio output device is much lower than the later arrived wave fronts. This is a psychoacoustic phenomenon often referred to as the Precedence Effect of the First Wave Front, (or Haas Effect). Therefore, providing a sound signal (or duplicated sound signals) simultaneously on the proximal and distal audio output devices with minimal active delay in accordance with aspects of the present invention is useful in addressing the issue of cross talk. This is because the proximal audio output devices are at close distance to the listener (left or right) ears, the listener (left or right) ear will hear the sound wave from the proximal audio outputs almost instantaneously upon the application of the electrical signals. In contrast, the acoustic waves from the distal audio outputs will reach the listener ear a short time later due to the acoustic transmission time. Because sound wave travels in air at a speed of approximately 340 m/s, a distance of 10 metre from the distal audio output devices the listener will result in an acoustic transmission delay of 34 ms. The crosstalk acoustic wave in this invention will always arrives later than the proximal wave, regardless where the listener is located. The crosstalk wave is therefore fused into and dominated by the proximal sound waves even when the proximal volume is much lower than the volume of the crosstalk resulted from the opposite distal speakers because the listener perceives the single fused auditory image and as a result fails to perceive any crosstalk. Therefore, crosstalk is essentially suppressed due to the precedence effect of the first wave fronts of the sound signal emitted from the proximal audio output devices.

If a listener is sufficiently far from the distal audio output source(s), it is possible that the delay between arrival of the sounds from the distal audio devices and the sounds from the proximal audio output devices exceeds the listener's echo delay threshold. The usual echo delay threshold is approximately 30 milliseconds equivalent to a distance of 10 metres. It is an option to introduce delay to the signals driving the proximal audio output devices in order to compensate for the acoustic transmission time of the sounds from the distal audio output sources to the listener. This invention makes the introduced delay unnecessary if the listener adheres to the optimum setting of the system and adjusts the volume of the proximal audio output devices to render the sounds emitted from the proximal audio output devices imperceptible to the listener but enough intensity to provide a cue signal for the first wave front precedence effect.

In a situation where there is a group of listeners and minimum distance between the distal audio output sources to the closest listener is known and the minimum acoustic transmission time is considered significant, it is preferable to delay the signals to the proximal audio output devices an amount equivalent to the minimum acoustic transmission time. In this way the effective space of the system is offset to start from the closest listener thus maximise the number of listeners situated in the space free of echo effect. This option however is not critical if all listeners adhere to the optimum setting of the system and adjust the volume of the proximal audio output devices to render the sounds emitted from the proximal audio output devices imperceptible to the listener but enough intensity to provide a cue signal for the first wave front precedence effect.

By way of example, the proximal audio output devices may be driven by a sound signal that is received from an audio source that also provides a sound signal for driving the distal audio output sources. Alternatively, duplicated audio sources may also be used for providing sound signals for each of the proximal and distal audio sources. It is understood that by employing the system, method and apparatus of the present invention, the listener receives sound output from the proximal audio output devices with minimal time delays when compared with the sound output from the distal audio output sources. Sound signals transmitted to the proximal audio output devices by wire or suitable wireless transmission means such as infrared transmission, experience minimal transmission delays when compared with the transmission of sound waves (emitted by the distal audio output sources) through air. As a result, by adopting aspects of the present invention, a listener receives the sound output from the proximal audio output device before hearing the sound output from the distal audio output sources and the associated crosstalk described earlier.

In an embodiment, a volume controller may be provided for controlling volume of the sound emitted by the one or more proximal audio output devices. Preferably, the volume controller may be further adapted for ensuring that the volume of the sound emitted by the one or more proximal audio output devices does not exceed a pre-determined level. The applicants have found that at least some listeners may prefer not to be distracted by the sounds emitted by the proximal audio output devices and prefer that a substantial part of the sounds heard by them is emitted by the distal audio output sources such as output devices like speakers. Therefore, adopting the volume controller, in at least some embodiments, is likely to improve a listener's overall listening experience.

It is found that, when the volume of the proximal audio output devices is set to be within a certain levels, the fused image appears to substantially come from the distal output sources. In other words, the sounds from the proximal audio output devices provide the first wave front therefore suppress the crosstalk, but are not “heard” by the listener. This is the optimum volume level where the sounds emitted from the proximal audio output devices become imperceptible to the listener but still have enough intensity to provide a cue signal for the first wave front precedence effect. At these volume levels of the proximal audio output devices, the listener experiences the spacious image coming substantially from the distal audio output sources, without the blurring effect caused by crosstalk.

In one embodiment, the sound signal driving each of the proximal audio output devices and distal audio sources may be provided by a common sound signal source. In an alternative embodiment, the proximal audio output devices may be driven by a first sound signal provided by a first sound signal source and the distal audio source may emit sounds provided by a second sound signal source wherein the first and second sound signals are substantially identical.

In a typical exemplary embodiment, it is envisioned that some aspects of the present invention may be deployed in confined listening spaces such as cinema theatres. By way of example, a listener may listen to the same soundtrack over the proximal output devices and the distal audio output sources. It is important to appreciate that the soundtrack may be provided to the proximal and distal audio output devices from the same audio source or a different audio source.

It is envisioned that in some alternative or additional embodiments, the proximal audio output devices may be driven by a sound signal that is received from microphones located at a distance from the listener far enough to ensure the acoustic crosstalk arrives later than the microphone signal to the proximal output devices. The microphones may be located at a pre-determined location and/or pre-determined angular orientation with respect to a listener sitting in a chair (or wheelchair). For example, the microphone may be located in front of the listener at a distal location during use. The use of the microphone allows the creation of the duplicated signal of substantially the same waveform as emitted by the distal sound sources positioned at a proximate location relative to the distal sound sources. The microphones may be coupled with the proximate audio output devices. Such an arrangement will allow the e proximal audio output devices to emit sounds which are similar or identical to the sounds emitted by the distal audio output sources. This arrangement is particularly desirable where the listener does not have access to electrical signals of the audio program such as in a live concert.

In another embodiment, the microphones could be positioned in front of the listener or the use for capturing sounds emitted from distally located audio sources. It is believed that some listeners suffer from abnormal hearing and are very sensitive to crosstalk. There are reports that some people suffer from Autism Spectrum Disorder show this tendency. Personal proximal audio output devices with judicially positioned microphones could overcome crosstalk effect in a natural acoustic environment such as at the market or on the streets. In this case the sound generated by the distal audio output devices is replaced with the surrounding sounds not under control by the listener.

Furthermore, one or more sound amplification means may also be provided for amplifying the sound signal driving the proximal audio output devices and distal audio sources. For example a listener using personal proximal audio output devices may use a personal amplifier to drive his own proximal audio output devices while the distal audio output sources are driven by the central amplification provided by the organiser.

Preferably, two proximal audio output devices are provided such that a first proximal audio output device is adapted to be located near the listener's left ear; and a second proximal audio output device is adapted to be located near the listener's right ear.

For example, the first and second proximal audio output devices may be provided in the form of earpieces located on a headset wherein the earpieces are adapted to be positioned in close proximity to the listener's ears.

The headset may be adapted for being mounted by a listener during use. The first and second proximal audio output devices provided on the headset may be adapted to be positioned relative to the listener's ears for allowing the listener to simultaneously hear the sound emitted by the proximal audio output devices and the distal audio source.

The first proximal audio output device may be adapted to be driven by a sound signal provided by a first proximal sound channel; and the second proximal audio output device may be adapted to be driven by the sound signal provided by a second proximal sound channel. For example, the first proximal sound channel may be provided in the form of a left earpiece electrical outlet that provides a sound signal to the left earpiece provided on the headset. Similarly, the second proximal sound channel may be provided in the form of a right earpiece electrical outlet that provides a sound signal to the right earpiece provided on the headset. By the way of example, this arrangement is often provided on airplanes where each seat is provided with stereo audio sockets suited for the personal headset provided by the airliner or by passengers.

In an alternative embodiment, the proximal audio output devices may be provided on a seating assembly such as a car seat or a chair. By way of example, the proximal audio output devices may be provided on a headrest of a car seat or a chair.

In an alternative embodiment, the proximal audio output devices may be provided on a multiple seating assembly such as seats positioned at a movie theatre. The proximal audio output devices may be provided on each headrest of every seat in the theatre. Alternatively each listener is provided with a headphone comprising two proximal audio output devices herein described in this invention.

In an embodiment, at least two groups of distal audio output sources in the form of output devices may be provided such that a first group of distal audio output devices comprises at least a first speaker; and a second group of distal audio output device comprises at least a second speaker.

Preferably, the first group of distal audio output devices may be adapted for use at the front left of a listener's location and the second group of distal audio output devices may be adapted for use at the front right of the listener's location.

The first group of distal audio output devices may be preferably adapted to be driven by a sound signal provided by a first distal sound channel; and the second group of distal audio output device is preferably adapted to be driven by a sound signal provided by a second distal sound channel. The first and second distal sound channels may also be referred to as left speaker channel and the right speaker channel respectively throughout the specification.

In a further embodiment, an additional third group of distal audio output devices may be provided. A third sound channel may also be provided for driving the third group of distal audio output devices. For example, the third distal audio output device may be in the form of central speaker adapted for use at a location that is substantially equidistant from the audio output devices of the first group and from the second group and located at the front of the listener's location.

In a further embodiment, the third sound channel may be duplicated and the duplicated channel may be used for driving one or more additional proximal audio output devices of a third type. The additional proximal audio output devices may be provided in the form of one or more additional or auxiliary earpieces. Alternatively, the duplicated channel may be used for driving the first and second proximal audio output devices using appropriate signal mixing techniques such as summing amplifier or summing resistors.

In yet another embodiment, a fourth group of distal audio output devices may also be provided. A fourth sound channel may also be provided for driving the fourth group of distal audio output devices. For example, the fourth distal audio output device may be in the form of a surround speaker adapted for use at a location that is substantially behind a listener during use.

The fourth sound channel may also be duplicated and the duplicated channel may be used for driving one or more additional proximal audio output devices of a fourth type. The additional proximal audio output devices may be provided in the form of one or more additional or auxiliary earpieces of a fourth type. Alternatively, the duplicated channel may be used for driving the first and second proximal audio output devices using appropriate signal mixing techniques such as summing amplifier or summing resistors.

### BRIEF DESCRIPTION OF DRAWINGS

Preferred features, embodiments and variations of the invention may be discerned from the following Detailed Description which provides sufficient information for those skilled in the art to perform the invention.

The Detailed Description is not to be regarded as limiting the scope of the preceding Summary of the Invention in any way. The Detailed Description will make reference to a number of drawings as follows:

FIG. 1 is a schematic diagram of a system 100 for suppressing crosstalk according to a preferred embodiment of the present invention.

FIG. 2 is a schematic diagram of a system 200 for suppressing crosstalk according to a second preferred embodiment of the present invention.

FIG. 3 is a schematic diagram of a system 300 for suppressing crosstalk according to a third preferred embodiment of the present invention.

FIG. 4 is a schematic diagram of a system 400 for suppressing crosstalk according to a fourth preferred embodiment of the present invention.

FIG. 5 is a perspective view of a headset 500 for suppressing crosstalk according to a fifth preferred embodiment of the present invention.

FIG. 6 is a schematic diagram of another system for supressing crosstalk.

### DETAILED DESCRIPTION OF PREFERRED EMBODIMENTS

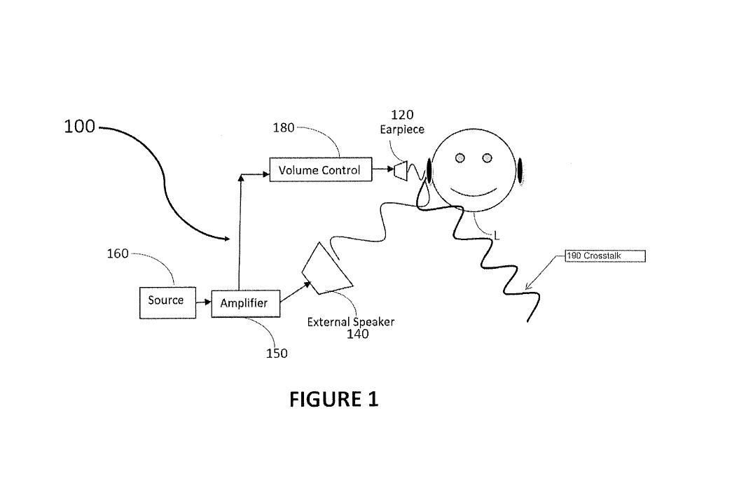

Referring now to FIG. 1 a crosstalk suppressing system 100 is illustrated. Specifically, in the present embodiment, the system 100 is provided for suppressing or minimising the effect of cross talk 190 from acoustic sound waves on the left of the listener and sensed by the listener's right ear.

A proximal audio output device is provided in the form of at least one earpiece or a small personal speaker in the form of an earpiece 120 located proximate to the right ear of the listener L. The design and position of the earpiece 120 is such that the positioning and configuration of the earpiece 120 allows the listener L to hear the original acoustic sound wave emitted by a distal audio output device provided in the form of a loudspeaker 140 as well as the sound wave emitted from the ear piece 120.

It is important to appreciate that the earpiece 120 (or small speaker) is located close to the listener's right ear (or proximate to the listener's left ear in an alternative embodiment) but leaves the right ear open to the air therefore causing minimal obstruction to the original acoustic sound wave emitted by the loudspeaker 140 that arrives at the right ear. In another embodiment, the earpiece 120 also allows the listener L to hear acoustic crosstalk 190 emitted from the left of the listener.

The earpiece 120 is connected to an electrical sound source which provides a copy of the original sound wave from an amplifier 150 in electrical form. The amplifier 150 receives a sound signal from sound source 160. As shown in the present embodiment, the earpiece 120 is connected electrically to the same amplifier 150 that also provides the sound signal to the external speaker 140. An electrical sound signal typically travels close to the speed of light compared to the speed of an acoustic wave (emitted by the external speaker 140) travelling through the air at a substantially slower speed. As a result, the soundwave from the earpiece 120 arrives at the listener ear before the arrival of the sound from the external speaker 140 or the crosstalk 190. In other alternative embodiments, the sound signal may be transmitted to the earpiece 120 by alternative transmission means including wireless signal transmission means.

A volume controller 180 is also provided for controlling the volume of sound from the earpiece 120. In at least some embodiments, the volume controller 180 is provided to allow the listener adjust the volume of the sound emitted by the earpiece 120 so that the listener can perceive the clearer sound substantially coming from the external speaker 140 and not discerns of the sound emitted from the earpiece 120.

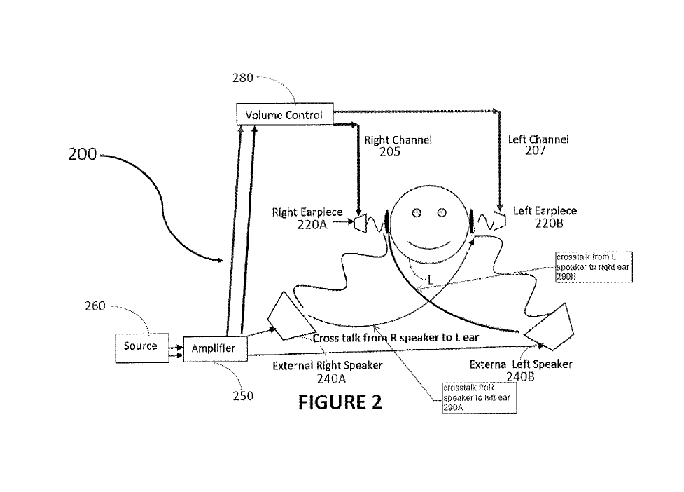

Referring to FIG. 2, another embodiment of a crosstalk suppressing system 200 is illustrated. Proximal audio output devices are provided in the form of two earpieces 220A and 220B that are located proximate to the right ear and left ear (respectively) of the listener L. Once again, the design and position of the earpieces 220A and 220B is such that the positioning and configuration of the earpiece 220 allows the listener L to hear the original acoustic sound wave emitted by a distal audio output devices provided in the form of a loudspeakers 240A and 240B as well as the sound wave emitted from the ear pieces 220. In so designed the earpieces 220A and 220B also allow the listener L's right and left ears to hear acoustic sound waves crosstalk 290B and crosstalk 290A from the speaker 240B and 240A respectively.

Unlike the previously described embodiment, the amplifier 250 provides the sound signal to the earpieces 220A and 220B by using 2 separate channels of sound, namely the left channel 207 and right channel 205. The left channel 207 is also configured for driving sound output from the external left loudspeaker 240B that is disposed at a predetermined distance from the listener L and positioned substantially on the left hand side of the listener L. Similarly, the right sound channel 205 is configured to drive output from the external right speaker 240A which is also disposed at a predetermined distance from the listener L and positioned on the right hand side of the listener L.

The sound source 260 represents an aural program that is designed for the listener L to be positioned at a predetermined location (also often referred to as the “sweet spot”) relative to the external left speaker 240B and the external right speaker 240B.

The volume control mechanism 280 for the left earpiece 220B and the right earpiece 220A is configured or programmed in a way that the dominant (louder) sound, as heard or perceived by the listener L, during use, is received from the external speakers 240A and 240B and the subordinate (softer or relatively less louder) sound, as heard or perceived by the listener L, is received from the earpieces 220A and 220B. The volume of the sound emitted by the earpieces 220A and 220B is optionally adjusted by the listener L or alternatively pre-set at a predetermined level relative to the external speakers preferably to render the sounds emitted from the proximal audio output devices 220A and 220B to be imperceptible to the listener but still have enough intensity to provide a cue signal for the first wave front precedence effect. The system 200 allows the listener L to hear the aural program from the external speakers 240A and 240B as if he is at or close to the sweet spot and addresses the problem of crosstalk even if the listener L is not equidistant from the sound sources.

As illustrated in FIG. 2, it is understood that the left ear of the listener L will receive three different soundwaves (each originating from different sources)
A. Direct sound wave from the external Left speaker 240B.
B. Indirect soundwave from the external Right speaker 240A. This indirect soundwave received by the listener's left ear is referred to in the art as crosstalk from the Right Channel to the Left ear.
C. Direct soundwave from the Left earpiece 220B. The direct soundwave is emitted by the left earpiece 220B arrives before the indirect soundwave (crosstalk) from the external right speaker 240A. In other words, the indirect soundwave (crosstalk) arrives later than the direct soundwave from the Left earpiece 220B by a slight delay as the result of acoustic transmission time in air from the Right speaker 240A to the listener's left ear.

Without being bound by theory, the applicants understand that the Precedence Effect (Haas effect), as explained in the earlier sections, will result in the listener's left ear merging any cross talk from the right speaker 240A with the soundwave of the left earpiece 220B (being the first to arrive). Similarly Haas effect will also make the right ear merge the soundwave from the left speaker 240B into that of the right earpiece 220A.

The left and right earpieces 220A and 220B may be provided in the form of a portable apparatus such as a headset device (not shown). Such a headset device when used in conjunction with the system 200 will consolidate all sound waves into a cue acoustic image produced by the earpieces 220A and 220B. As explained earlier, the volume of the sound emitted by the earpieces 220A and 220B (as heard by the listener during use) does not necessarily need to be overwhelming so that the listener's ear interprets the sound to be originating due to the acoustic sound wave emitted by the external speakers 240A and 240B.

It is found in this invention that, when the volume of the proximal audio output devices 220A and 220B is set to be within a certain levels, the listener perceives the fused image to appear to substantially originate from the distal output devices 240A and 240B. In other words, the sounds from the proximal audio output devices 220A and 220B provide the first wave front which suppresses the crosstalk. At an optimum volume level, the sounds emitted from the proximal audio output devices 220A and 220B become imperceptible to the listener. However, the sound emitted by the proximal audio device 220A and 220B may have enough intensity to provide a cue signal for the first wave front precedence effect. At these volume levels of the proximal audio output devices 220A and 220B, the listener may experience the spacious audio image to be originating substantially from the distal audio output devices 240A and 240B, without perceiving the blurring effect caused by crosstalk.

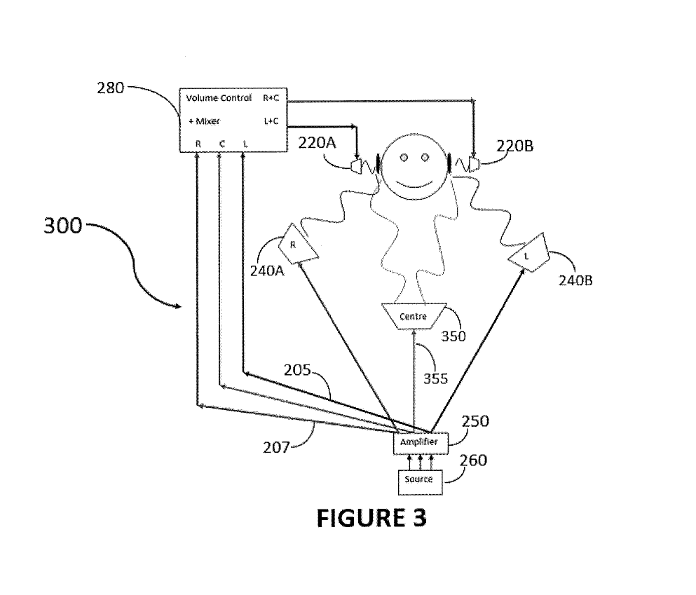

Referring to FIG. 3, a third embodiment of the present invention is illustrated in the form of a crosstalk suppression system 300. Like reference numerals in FIG. 3 represent features that have been previously described in earlier sections. The main difference between the crosstalk suppression system 300 when compared with the previously described system 200 is that an additional distal audio output device in the form of a central speaker 350 is provided. A central sound channel 355 is used for driving the central speaker 350. Furthermore, the central sound channel 355 is duplicated and the same sound signal from the central sound channel 355 is also delivered to earpieces 220A and 220B. The duplicated central channel 355 is designed for driving output from the left earpiece 220B and the right earpiece 220A by electronically mixing the sound signal from central channel 355 with the sound signal from the left channel 207 for output from the left earpiece 220A and by electronically mixing the sound signal from the central channel 355 with the right channel 205 for output from right earpiece 220B in signal mixer 285. In an alternative embodiment, the duplicated central channel 355 may also be directed to at least one additional earpiece such as a central earpiece disposed at a predetermined distance from the listener's left and right ears. The volume control mechanism 280 may be configured for also controlling the volume of the central speaker 350 and/or for controlling the sound signal transmitted through the central channel 355.

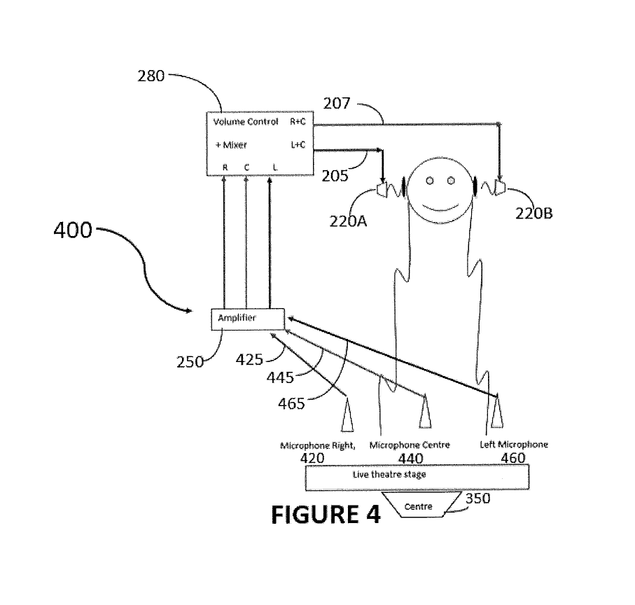

Referring to FIG. 4, a fourth embodiment of the present invention is illustrated in the form of crosstalk suppression system 400. Like reference numerals in FIG. 4 represent features that have been previously described. The main difference between the previously described embodiment and system 400 is that microphones 420, 440 and 460 are provided in the vicinity of a distal sound source (namely a live theatre stage). Each of the microphones 420, 440, 460 receive a respective sound signal from the distal sound source and transmit the sound signal along microphone channels 425, 445 and 465 respectively to the amplifier 250. The amplifier 250 subsequently amplifies the received sound signal and transmits the sound signals along the left channel 207 and the right channel 205 to the earpieces 220A and 220B respectively. Once again system 400 also provides for transmission of the sound signal to the earpieces 220A and 220B without any active delay relative to the sound from the stage. As a result of the output of sound from the earpieces 220A and 220 (without active delay), is subsequently followed by sound from the live theatre stage (which typically needs to travel through air, causing the slight delay). Due to the relatively short time delay, the listener perceives a single fused auditory image (due to Haas effect). As a result, providing a sound signal simultaneously on the earpieces 220A and 220B and by way of using the microphones 420, 440 and 460 positioned in close proximity to live theatre stage and located relatively away from the listener, without a active delay results in a psychoacoustic effect for the listener L. As a result, the listener L fuses the cross talk sound signal with the initial sound signal (received from the earpieces 220A and 220B) to form a fused acoustic image.

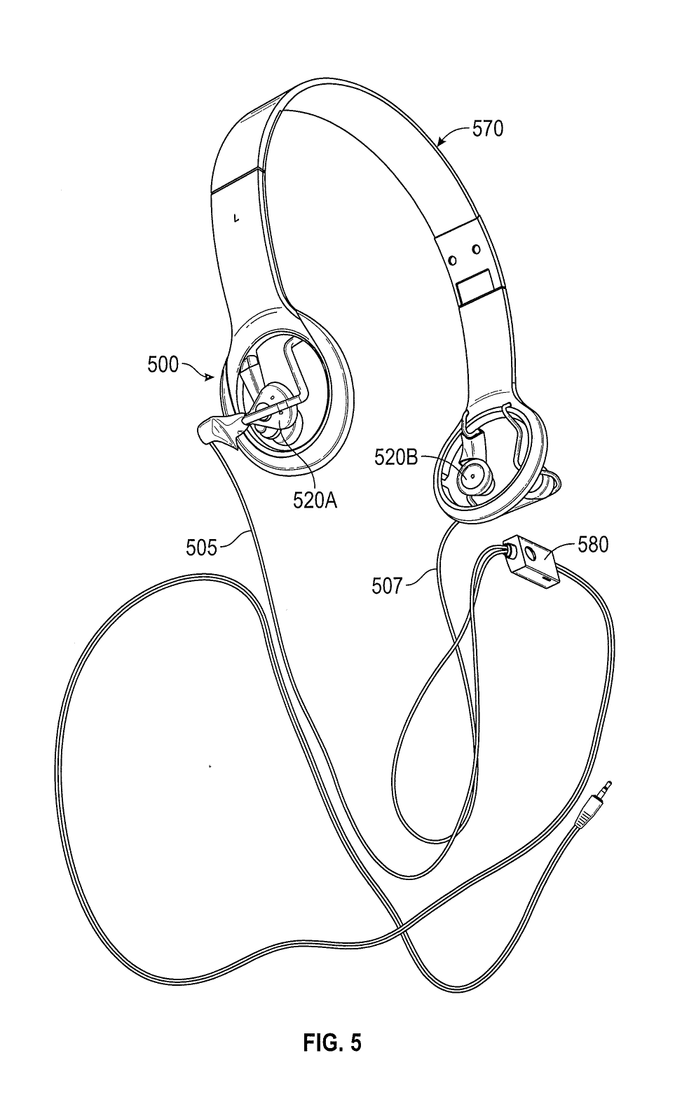

Referring to FIG. 5, an apparatus embodiment in form of a crosstalk suppressing headset 500 is illustrated. The headset 500 may be used in conjunction with any one of the system embodiments 200, 300 or 400 as previously discussed.

Proximal audio output devices are provided in the form of two earpieces 520A and 520B that are located proximate to the right ear and left ear (respectively) of the listener L when the headset 500 is mounted on a user's head. Each of the earpieces 520A and 520B comprises an integrated speaker that allows sound to be emitted within close proximity of the listener's ears. As will be evident from FIG. 5, the earpieces 520A and 520B are positioned along the headset frame 570 such that during use, the listener can also listen to sounds emanating from distally located audio output devices (such as loudspeakers located relatively away from the user when compared with the location of the earpieces 520A and 520B). The headset 500 allows the listener L to hear an original acoustic sound wave emitted by a distally located loudspeaker (not shown) as well as the sound wave emitted from the ear pieces 520. Each of the earpieces 520A and 520B is connected by way of connecting wires 505 and 507 that are adapted for receiving sound signals from a respective left and right channel (as explained in previous sections). A volume control mechanism 580 allows for the volume of sound emanating from the earpieces 520A and 520B to be conveniently controlled by the listener to a pre-determined level.

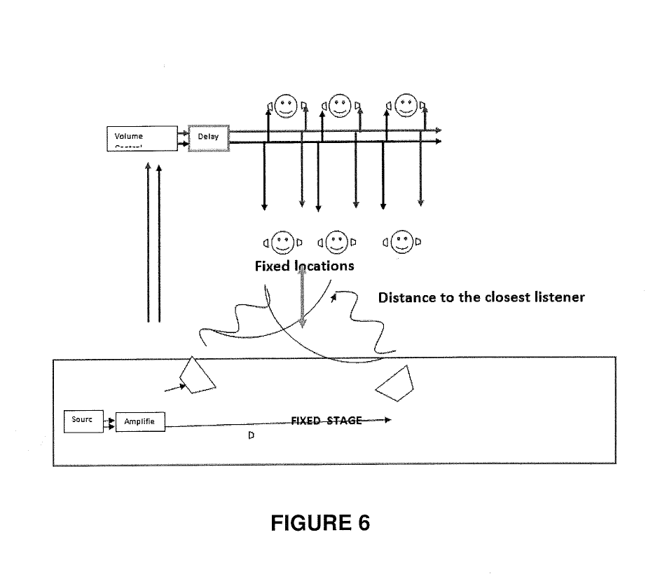

Referring to FIG. 6, another embodiment of the present invention is illustrated. As shown in FIG. 6, a group of listeners and earpieces associated with each of the listeners are positioned away from the distal audio outputs, namely the external loudspeakers. The method of supressing crosstalk in accordance with this embodiment requires that the minimum distance between the distal audio output devices to the closest listener is measured. Based on the minimum distance and the minimum acoustic transmission time can be calculated. If the transmission time is considered significant, then the system optionally allows the introduction of an active delay for delaying the sound signals to the proximal audio output devices associated with one or more of the group of listeners. The introduced delay may be equivalent to compensate for the minimum acoustic transmission time. In this way, the effective space of the system is offset to start from the closest listener thereby maximising the number of listeners situated in the space and addressing or supressing the echo effect. It is important to note that the introduction of the active delay is optional and may largely depend on the dimension of the physical space in which the group of listeners are located. The present embodiment aims to allow users to optionally introduce an active delay and adjust the volume of the proximal audio output devices to render the sounds emitted from the proximal audio output devices to be imperceptible to the listener but still have enough intensity to provide a cue signal for the first wave front precedence effect.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A crosstalk suppression system comprising:
one or more proximal audio output devices located proximal to a listener's left and/or right ear; and
one or more distal audio output sources located relatively away from the listener's ears;
wherein each of the proximal output devices and the distal audio output sources are adapted to emit a substantially identical sound without introducing an active time delay for the sound emitted from the proximal audio output devices and the distal audio output sources such that during use the listener's left and/or right ear receives sound from the proximal audio output devices before or at the same time relative to the sound received by the listener's ear from the distal audio output sources and wherein loudness of the sound emitted from the proximal audio output devices, as heard by the listener's ears, does not exceed a loudness of the sound emitted from the distal audio output sources, as heard by the listener's ears.

2. A crosstalk suppression system in accordance with claim 1 wherein the proximal audio output devices comprise at least a left proximal audio output device positioned in close proximity to the listener's left ear and a right proximal audio output device positioned in close proximity to the listener's right ear such that during use the sound emitted from the right earpiece is substantially directed to the listener's right ear and the sound emitted from the left earpiece is substantially directed to the listener's left ear.

3. A crosstalk suppression system in accordance with claim 2 wherein said left proximal audio output device comprises a left earpiece and said right proximal audio output device comprises a right earpiece wherein the left and right earpiece are preferably provided on a headset.

4. A crosstalk suppression system in accordance with claim 3 wherein the proximal audio output device further comprises an additional group of proximal audio output devices positioned adjacent said left proximal audio output device and/or right audio output device.

5. A crosstalk suppression system in accordance with claim 1 wherein the sound emitted by the proximal output devices and the distal audio sources is provided by the same audio signal source.

6. A crosstalk suppression system in accordance with any one of claim 1 wherein the sound emitted by the proximal audio output devices and the distal audio output sources is provided by different audio signal sources.

7. A crosstalk suppression system in accordance with claim 1 further comprising one or more volume controllers for controlling volume of the sound emitted by the one or more proximal audio output devices.

8. A crosstalk suppression system in accordance with claim 7 wherein the one or more volume controllers are adapted to allow adjustment of volume for several frequency bands.

9. A crosstalk suppression system in accordance with claim 1 wherein the proximal audio output devices are driven by sound signals provided by the one or more sound channels wherein the sound signals are received from microphones located for sensing sound emitted by the distal audio output sources and transmitting the received sound to the proximal audio output devices.

10. A crosstalk suppression system in accordance with claim 1 wherein said distal audio output sources comprise at least two groups of distal audio output sources wherein a first group of distal audio output sources comprises at least a first speaker; and a second group of distal audio output sources comprises at least a second speaker and wherein the first group of distal audio output sources is adapted for use at the front left of a listener's location and the second group of distal audio sources is adapted for use at the front right of the listener's location.

11. A crosstalk suppression system in accordance with claim 10 further comprising a third group of distal audio output sources comprising at least a third speaker adapted for use at a location that is substantially equidistant from the audio output devices of the first group and from the second group and located at the front of the listener's location.

12. A crosstalk suppression system in accordance with claim 11 further comprising a fourth group of distal audio output sources comprising at least a fourth speaker adapted for use at a location that is located substantially behind the listener during use.

13. A cross talk suppression apparatus, the apparatus comprising:
a frame having one or more proximal audio output devices located proximal to a listener's left and/or right ear to allow the listener to receive at least a first sound output from said one or more proximal audio output devices wherein the proximal audio output devices are adapted to be connected to one or more audio input interfaces, said interfaces being adapted to generate one or more sounds that are substantially identical to one or more sounds emitted by one or more distal sound sources located relatively away from the listener's ears,
the proximal audio output devices being mounted on the frame in a spaced relationship relative to the listener's left and/or right ear in a listening configuration to allow the listener to simultaneously receive a first and second sound output, the first output being provided by the proximal audio output devices and the second output being provided by the one or more distal audio output sources; and
one or more volume controllers for controlling volume of the sound emitted by the one or more proximal audio output devices wherein preferably the one or more volume controllers are adapted for ensuring that the volume of the sound emitted by the one or more proximal audio output devices, as heard by the listener's ears, does not exceed loudness of distal sounds, as heard by the listener's ears.

14. A crosstalk suppression apparatus in accordance with claim 13 wherein said one or more proximal audio output devices comprises a left earpiece positioned to substantially expose the left ear and left ear canal to the air and a right earpiece positioned to substantially expose the right ear and right ear canal to the air.

15. A crosstalk suppression apparatus in accordance with any one of claims 13 wherein the frame comprises a left earpiece mounting portion for mounting the left earpiece in a spaced relationship from the left ear and a right earpiece mounting portion for mounting the right earpiece in a spaced relationship from the right ear, said earpiece mounting portions being located at end portions of a headband portion.

16. A method for suppressing crosstalk for a listener, the method comprising:
driving one or more proximal audio output devices for emitting a first sound output, the proximal audio output devices being located proximal to the listener's left and/or right ear; and
driving one or more distal audio output devices for emitting a second sound output, the distal audio output devices being located relatively away from the listener without introducing an active time delay for the sound signal driving each of the proximal and the distal audio output devices;
wherein the listener's left and/or right ear receives sound from the proximal audio output devices before or at the same time relative to the sound received by the listener's ear from the distal audio output devices and
wherein loudness of the sound emitted from the proximal audio output devices, as heard by the listener's ears, does not exceed a loudness of the sound emitted from the distal audio output devices, as heard by the listener's ears.
